(19) United States
(12) Patent Application Publication
(10) Pub. No.: US 2026/0110850 A1
(43) Pub. Date: Apr. 23, 2026

(54) ANGLE INSENSITIVE OPTICAL ARRANGEMENT FOR OPTICAL SWITCH

(71) Applicant: Lumentum Operations LLC, San Jose, CA (US)

(72) Inventors: Kwun Sing CHAN, Ottawa (CA); Sheldon MCLAUGHLIN, Ottawa (CA)

(21) Appl. No.: 18/976,535

(22) Filed: Dec. 11, 2024

Related U.S. Application Data
(60) Provisional application No. 63/708,578, filed on Oct. 17, 2024.

(51) Int. Cl. G02B 6/35; G02B 6/27; G02B 6/293

(52) U.S. Cl. CPC G02B 6/3594; G02B 6/272; G02B 6/29373; G02B 6/3548; G02B 6/356

(57) ABSTRACT

An optical arrangement includes a first optical component configured to split an input beam into two orthogonally polarized beams including a first polarized beam and a second polarized beam directed along first and second optical paths, respectively; a second optical component configured to receive the second polarized beam, rotate a polarization of the second polarized beam to produce a third polarized beam, and direct the third polarized beam further along the second optical path; and a prism arrangement that includes a first prism section including a first pair of optically coupled interfaces configured to redirect the first polarized beam, at a first redirection angle, along a redirected path segment of the first optical path; and a second prism section including a second pair of optically coupled interfaces configured to redirect the third polarized beam, at a second redirection angle, along a redirected path segment of the second optical path.

### CROSS-REFERENCE TO RELATED APPLICATION

This Patent Application claims priority to U.S. Provisional Ser. No. 63/708,578, filed on Oct. 17, 2024, and entitled “POLARIZATION DEPENDENT LOSS SENSITIVITY REDUCTION USING OPTICAL CONTACT BONDED PRISMS ON BACKEND VERTICAL POLARIZATION SPLIT WAVELENGTH SELECTIVE SWITCH.” The disclosure of the prior Application is considered part of and is incorporated by reference into this Patent Application.

### TECHNICAL FIELD

The present disclosure relates generally to optical switches, such as wavelength selective switches.

### BACKGROUND

A wavelength selective switch (WSS) is a type of optical switch that is widely used for dynamic routing of wavelength channels in optical communications networks. WSS devices may be deployed in optical switching nodes of long-haul, regional, and metro optical communications networks.

Long-wavelength band and conventional band ranges are typically referred to as L band and C band, respectively. There is a growing demand for wide band (C+L band) and high port count WSS devices in the industry. These WSS devices need to allow for selecting a flexible optical channel width to be directed to an output. Setting a channel width of a channel, and beam steering of the channel, are usually accomplished by a liquid crystal on silicon (LCOS) chip. An LCOS is a miniaturized reflective active-matrix liquid-crystal display or “microdisplay” using a liquid crystal layer on top of a silicon backplane. The LCOS may also be referred to as a spatial light modulator or director array. LCOS-based beam steering typically requires that an incident beam has a single polarization orientation that is aligned to a direction in which the LCOS is operating.

In a WSS device, a polarization is usually selected in front-end optics of the WSS device (e.g., near the input/output fibers). This is done by, first, splitting an input beam into two orthogonal polarizations, and second, rotating one of the polarizations such that both beams have a same polarization. These beams are relayed to the LCOS through other optical components of the WSS device.

### SUMMARY

In some implementations, an optical system includes a beam steering system configured with a beam-steering dependency dependent on a first polarization, wherein the beam steering system is configured to steer only light having the first polarization; and an optical arrangement comprising an input, a first optical path, and a second optical path, wherein the input is configured to receive an input beam with an arbitrary polarization state, and wherein the first optical path and the second optical path are colinear at the input and are incident on the beam steering system at a different points-of-incidence, wherein the optical arrangement further comprises: a first optical component configured to split the input beam into two orthogonally polarized beams including a first polarized beam and a second polarized beam, wherein the first optical component is configured to direct the first polarized beam along the first optical path with the first polarization, and direct the second polarized beam along the second optical path with a second polarization that is orthogonal to the first polarization; a second optical component configured to receive the second polarized beam, rotate the second polarization of the second polarized beam into the first polarization, and direct the second polarized beam further along the second optical path with the first polarization; and a prism arrangement comprising: a first prism section arranged in the first optical path, the first prism section comprising a first pair of optically coupled interfaces configured to redirect the first polarized beam, at a first redirection angle, at the beam steering system, wherein the first redirection angle is rotationally insensitive to external influences; and a second prism section arranged in the second optical path, the second prism section comprising a second pair of optically coupled interfaces configured to redirect the second polarized beam, with the first polarization, at a second redirection angle, at the beam steering system, wherein the second redirection angle is rotationally insensitive to the external influences.

In some implementations, an optical arrangement for a wavelength selective switch includes a first optical component configured to split an input beam into two orthogonally polarized beams including a first polarized beam and a second polarized beam, wherein the first optical component is configured to direct the first polarized beam along a first optical path with a first polarization, and direct the second polarized beam along a second optical path with a second polarization that is orthogonal to the first polarization; a second optical component configured to receive the second polarized beam, rotate the second polarization of the second polarized beam into the first polarization to produce a third polarized beam, and direct the third polarized beam further along the second optical path; and a prism arrangement comprising: a first prism section arranged in the first optical path, the first prism section comprising a first pair of optically coupled interfaces configured to redirect the first polarized beam, at a first redirection angle, along a redirected path segment of the first optical path, wherein the first redirection angle is rotationally insensitive to external influences; and a second prism section arranged in the second optical path, the second prism section comprising a second pair of optically coupled interfaces configured to redirect the third polarized beam, at a second redirection angle, along a redirected path segment of the second optical path, wherein the second redirection angle is rotationally insensitive to the external influences, wherein the redirected path segment of first optical path is parallel or antiparallel to the redirected path segment of second optical path.

### BRIEF DESCRIPTION OF THE DRAWINGS

FIG. 1 shows an optical system according to one or more implementations.

FIG. 2 shows an optical system according to one or more implementations.

FIG. 3 shows an optical system according to one or more implementations.

### DETAILED DESCRIPTION

The following detailed description of example implementations refers to the accompanying drawings. The same reference numbers in different drawings may identify the same or similar elements.

A WSS device may have a vertical polarization split design that requires manipulating and maintaining optical path distances for two orthogonal polarizations. For example, some polarization-dependent optical arrangements split incoming light into two beams (e.g., two polarizations), and the two beams have different propagation times. Since the two orthogonal polarizations are separated, relative shifts between the two optical paths of the two orthogonal polarizations may result in a polarization dependent loss (PDL). Moreover, the different propagation times (e.g., resultant from an optical path length difference) lead to a differential group delay (DGD), also called polarization mode dispersion (PMD). Thus, relative shifts between the two optical paths result in PDL, an optical path length difference introduces PMD, and propagating in different materials introduces shifts in optical focus. As a result, a relative stability of the two optical paths is difficult to maintain.

In addition, some WSS devices include a prism assembled with multiple prism sections that are made out of different materials that have different refractive indices. By using different materials that have different refractive indices, a focus point of both beams can be made to lie in a plane of an LCOS, even though a second beam path of a second beam is physically longer than a first beam path of a first beam. However, this arrangement has a serious disadvantage in that the two beams (e.g., the two polarizations) have different propagation times, which leads to PMD. Moreover, different parts of the prism may be bonded together by epoxy, which creates epoxy joints (e.g., epoxy interfaces) that cause the light beams to diverge slightly from a desired optical path. In other words, the epoxy interfaces between the different parts may cause deviations in optical paths, leading to PDL, PMD, and/or shifts in optical focus of the light beams. This disadvantage may make such an approach unsuitable for processing light beams that have high bit rate modulation.

Some WSS devices may include one or more mirrors to redirect light along an optical path. However, the mirrors may be rotationally sensitive to one or more external influences, such as temperature and/or aging effects. In other words, a reflection angle of a mirror may shift, change, or rotate due to one or more external influences, which may cause a reflected beam to deviate from an intended path. Moreover, the two beams may interact with different mirrors that respond differently to the one or more external influences. As a result, the two reflected beams may deviate from respective intended paths by different amounts. These deviations from the respective intended paths may introduce differences in optical paths, leading to PDL, DGD, PMD, and/or shifts in optical focus of the light beams.

Some implementations described herein provide a prism arrangement that includes respective prism sections for two optical paths. The prism arrangement may be used in an optical switch, such as a WSS. A first prism section is arranged in a first optical path. The first prism section may include a first pair of optically coupled interfaces configured to redirect a first polarized beam, at a first redirection angle, along a redirected path segment of the first optical path. The first redirection angle may be rotationally insensitive to external influences. In other words, the first pair of optically coupled interfaces may be, in combination, rotationally insensitive to external influences. Thus, if one optically coupled interface of the first pair of optically coupled interfaces experiences a rotational shift, the other optically coupled interface of the first pair of optically coupled interfaces experiences a rotational shift in a manner such that the first redirection angle remains constant. A second prism section is arranged in a second optical path. The second prism section may include a second pair of optically coupled interfaces configured to redirect a second polarized beam, at a second redirection angle, along a redirected path segment of the second optical path. The second redirection angle may be rotationally insensitive to the external influences. Thus, if one optically coupled interface of the second pair of optically coupled interfaces experiences a rotational shift, the other optically coupled interface of the second pair of optically coupled interfaces experiences a rotational shift in a manner such that the second redirection angle remains constant. Moreover, the redirected path segment of first optical path may be parallel or antiparallel to the redirected path segment of second optical path.

As a result of the first redirection angle and the second redirection angle being rotationally insensitive, optical path lengths of the two optical paths may be maintained to be equal despite one or more external influences being present that may have otherwise altered a trajectory of one or more reflected beams away from an intended path, resulting in optical path length differences between the two optical paths. Thus, PDL, DGD, and/or PMD can be reduced or prevented.

A third prism section may be provided that is arranged in at least one of the first optical path or the second optical path. The third prism section may equalize respective path lengths of the first optical path and the second optical path such that the first optical path and the second optical path have equal optical path lengths. An optical path length may be defined by a physical path length of the optical path and a refractive index of one or more materials through which the optical path length extends. For example, the optical path length may be a product of the physical path length and the refractive index.

In some implementations, the third prism section is configured to equalize respective path lengths of the first optical path and the second optical path such that the first optical path and the second optical path have equal physical path lengths. In some implementations, the first prism section, the second prism section, and the third prism section are made of a same optical material. In other words, the first prism section, the second prism section, and the third prism section may have a same refractive index. For example, the first prism section, the second prism section, and the third prism section are made of a same glass material.

In some implementations, the first prism section, the second prism section, and the third prism section may be optically bonded together such that interfaces between conjoined prism sections is absent. For example, the third prism section may be optically bonded to the first prism section and the second prism section such that the first prism section, the second prism section, and the third prism section form a one-piece integral structure made of a homogeneous medium. In some implementations, the prism arrangement, formed by the prism sections, may be devoid of epoxy interfaces. As a result, an integrity of each optical path may be improved and the prism arrangement may provide more accurate beam trajectories, while maintaining equal optical path lengths between the two optical paths.

In some implementations, the first prism section and the second prism section may be respective folding prisms for the two optical paths. The folding prisms may be configured to be rotation insensitive. A geometric arrangement of a WSS device that includes the prism arrangement may be designed to ensure that the two optical paths travel through an amount of glass material such that both a phase accumulation and focusing properties of the two optical paths remain the same. By maintaining the phase accumulation of the two optical paths to be the same, PMD can be reduced or eliminated. Thus, a sensitivity of the WSS device to PMD can be reduced.

In addition, optical components of the WSS device may formed of the same material and may be bonded together, at respective contact interfaces, by optical contact bonds that are made of the same material that is used for the components. By using a same material for the optical contact bonds, the prism arrangement of the WSS device may be formed as a single integral structure with no apparent internal interfaces. As a result, light propagating through one or more contact regions at which two prism sections are optically bonded may not be affected by the contact interfaces, and may propagate through adjacent prism sections as though the adjacent prism sections were a single piece of a fully homogeneous medium. In other words, despite being formed by two or more prism sections, the prism sections may be bonded by optical contact bonds in such a way that the prism arrangement functions as if it were a single piece of a fully homogeneous medium. A light beam passing through a contact interface remains entirely linear or straight, with no deviation. Thus, the light beam on one side of the contact interface is colinear with the light beam on the other side of the contact interface, which may enhance the focusing properties of the WSS device. The optical contact bonds may eliminate many shift-sensitive joints found in conventional vertical polarization split WSS designs.

The WSS device may be designed to reduce a number of rotationally sensitive components in order to reduce or eliminate the optical path length differences between the two optical paths. The WSS device may include a penta prism and a dove prism as shift-insensitive folding elements. Thus, the WSS device may eliminate rotational sensitivity in the two most sensitive components of the optical system, making the WSS device more manufacturable (e.g., easier and less expensive to manufacture), compared to conventional WSS devices. Additionally, the WSS device may be designed to reduce a number of shift-sensitive epoxy joints in the optical system.

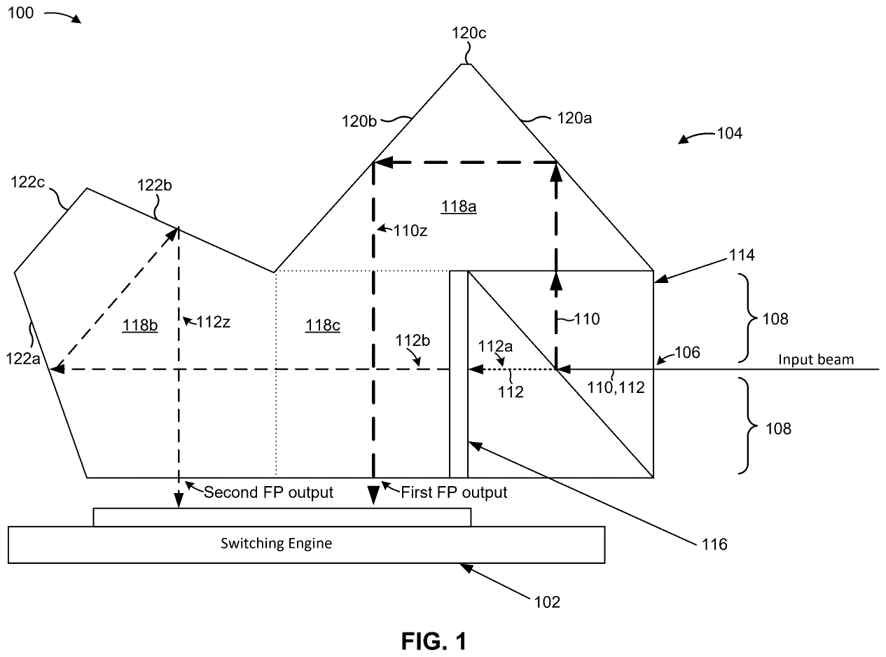

FIG. 1 shows an optical system 100 according to one or more implementations. The optical system 100 may be part of a WSS. The optical system 100 may have a vertical polarization splitting configuration. The optical system 100 may include a beam steering system 102 and an optical arrangement 104.

The beam steering system 102 may include one or more beam steering devices that are configured with a beam-steering dependency dependent on a polarization, such as a P-polarization or an S-polarization. For example, the beam steering system 102 may be configured to steer only light having a first polarization (e.g., the P-polarization). A beam steering device may be a switching engine that is configured to steer light to an optical output port selected from a plurality of optical output ports. Thus, the switching engine may be used to switch an optical output of the optical system 100. In some implementations, a beam steering device may be a polarization-dependent LCOS array, a polarization-dependent spatial light modulator, or a polarization-dependent light director array. The beam steering system 102 may be configured to steer two polarized light beams to a common output direction. However, in order to simultaneously steer the two polarized light beams, the two polarized light beams incident on the beam steering system 102 must have a same polarization orientation as the polarization in which the beam steering system 102 operates. Thus, if the beam steering system 102 is configured to steer light having the first polarization, the two polarized light beams must have the first polarization at the beam steering system 102.

The optical arrangement 104 may include a plurality of optical components configured to guide the two polarized light beams along respective optical paths. The optical arrangement 104 may include an input 106 (e.g., an optical input), an output 108 (e.g., an optical output), a first optical path 110, and a second optical path 112. The input 106 may receive an input beam with an arbitrary polarization state (e.g., an unpolarized state). Thus, the input beam may contain P-polarized and S-polarized components (e.g., a first polarized beam and a second polarized beam). The first optical path 110 and the second optical path 112 may be colinear at the input 106 and may be incident on the beam steering system 102 at a different points-of-incidence. Thus, the first optical path 110 and the second optical path 112 may extend from the input 106 to different regions of the beam steering system 102.

During operation, the beam steering system 102 may reflect light back on respective first and second output paths that correspond to an output direction. The first and second output paths may be colinear at the output 108. An angle of the output direction at the output 108 may depend on the steering by the beam steering system 102 (e.g., to correspond to a desired output direction or output port). For example, the beam steering system 102 may steer the trajectories of the first and second output paths by changing an angle of reflection at the beam steering system 102 such that the angle of the output direction at the output 108 changes. The angle of the output direction of the first and second output paths at the output 108 may depend on the steering by one or more LCOSs of the beam steering system 102. In other words, the beam steering system 102 may simultaneously receive and steer both the first polarized beam and the second polarized beam such that the first polarized beam and the second polarized beam are eventually combined by the optical arrangement 104 into a combined output beam that is output from the output 108 in the common output direction. The common output direction may depend on a beam steering angle of the beam steering system 102.

The output 108 may be referred to as a counter propagation (CP) output for counter propagating light. For example, the beam steering system 102 may receive forward propagating light (e.g., input light) and reflect the forward propagating light as the counter propagating light (e.g., output light). Thus, the counter propagating light may propagate through the optical system 100 in a direction that is counter to the forward propagating light. The first optical path 110 and the second optical path 112 are illustrated as forward propagation (FP) paths. The first and second output paths may be referred to as CP paths. When the optical arrangement 104 is implemented in a WSS device, the optical arrangement 104 may include additional optical components configured to collimate the first polarized beam and the second polarized beam in a port switching direction and focus the first polarized beam and the second polarized beam in a wavelength dispersion direction.

The optical arrangement 104 may include a first optical component 114 and a second optical component 116. The first optical component 114 may split the input beam into two orthogonally polarized beams (e.g., two orthogonal linear polarizations) including the first polarized beam and the second polarized beam. The first optical component 114 may direct the first polarized beam along the first optical path 110 with the first polarization, such as a P-polarization. Additionally, the first optical component 114 may direct the second polarized beam along the second optical path 112 with a second polarization, such as an S-polarization, that is orthogonal to the first polarization. In some implementations, the first optical component 114 may be a polarization beam splitter (PBS) arranged on the first optical path 110 and the second optical path 112.

The second optical component 116 may receive the second polarized beam, rotate the second polarization of the second polarized beam into the first polarization, and direct the second polarized beam further along the second optical path 112 with the first polarization. In other words, the second optical component 116 may convert the second polarization of the second polarized beam into the first polarization such that both the first polarized beam and the second polarized beam have the same polarization (e.g., the first polarization or P-polarization) at the beam steering system 102. Thus, a first segment 112a of the second optical path 112 may guide the second polarized beam with the second polarization, and a second segment 112b of the second optical path 112 may guide the second polarized beam with the first polarization. In some implementations, the second optical component 116 may convert the second polarization of the second polarized beam into the first polarization by a 90-degree rotation of the second polarization. In some implementations, the second optical component 116 may be a half-wave retarder (HWR), such as a half-wave plate (HWP). In some implementations, the second optical component 116 may be a zero-order half-wave plate.

In some implementations, the second polarized beam with the first polarization may be referred to as a third polarized beam. The second optical component 116 may receive the second polarized beam (with the second polarization), rotate the second polarization of the second polarized beam into the first polarization to produce the third polarized beam, and direct the third polarized beam further along the second optical path 112. In the example shown in FIG. 1, the beam steering system 102 is a single switching engine arranged on the first optical path 110 and the second optical path 112. Thus, the single switching engine may be configured to receive the first polarized beam and the second polarized beam, with the first polarization (e.g., the third polarized beam).

The optical arrangement 104 may include a prism arrangement that includes a first prism section 118a, a second prism section 118b, and a third prism section 118c. The first prism section 118a may be arranged in the first optical path 110. Additionally, the first prism section 118a may include a first pair of optically coupled interfaces 120a, 120b configured to redirect the first polarized beam, at a first redirection angle, at the beam steering system 102. The first pair of optically coupled interfaces 120a, 120b may redirect the first polarized beam, at the first redirection angle, along a redirected path segment 110z of the first optical path 110. The first redirection angle is rotationally insensitive to external influences, such as temperature and/or aging effects. The redirected path segment 110z of the first optical path 110 may extend from an output of the first pair of optically coupled interfaces 120a, 120b to the beam steering system 102. In some implementations, the first redirection angle may be 180°. Thus, the first pair of optically coupled interfaces 120a, 120b may redirect or otherwise rotate a propagation direction of the first polarized beam 180°.

In addition, the first pair of optically coupled interfaces 120a, 120b may extend at a first relative angle to each other, and the first relative angle is fixed and is rotationally insensitive to the external influences. For example, the first prism section 118a may include a plurality of first sides, including the first pair of optically coupled interfaces 120a, 120b, and the first pair of optically coupled interfaces 120a, 120b may be physically coupled by at least one intervening side 120c of the plurality of first sides such that the first relative angle is fixed and is rotationally insensitive to the external influences. Alternatively, the first pair of optically coupled interfaces 120a, 120b may join at a single point. In some implementations, the first pair of optically coupled interfaces 120a, 120b may form a first folding optics arrangement that is rotationally insensitive to the external influences. In some implementations, the first prism section 118a may be a dove prism.

The second prism section 118b may be arranged in the second optical path. The second prism section 118b may include a second pair of optically coupled interfaces 122a, 122b configured to redirect the second polarized beam, with the first polarization (e.g., the third polarized beam), at a second redirection angle, at the beam steering system 102. The second pair of optically coupled interfaces 122a, 122b may redirect the second polarized beam, with the first polarization, at the second redirection angle, along a redirected path segment 112z of the second optical path 112. The second redirection angle is rotationally insensitive to the external influences. The redirected path segment 112z of the second optical path 112 may extend from an output of the second pair of optically coupled interfaces 122a, 122b to the beam steering system 102. The second pair of optically coupled interfaces 122a, 122b may redirect the second polarized beam, with the first polarization, at the second redirection angle, such that the redirected path segment 112z of the second optical path 112 is parallel to the redirected path segment 110z of the first optical path 110. In some implementations, the second redirection angle may be 90°. Thus, the second pair of optically coupled interfaces 122a, 122b may redirect or otherwise rotate a propagation direction of the second polarized beam, with the first polarization, 90°.

In addition, the second pair of optically coupled interfaces 122a, 122b may extend at a second relative angle to each other, and the second relative angle is fixed and is rotationally insensitive to the external influences. For example, the second prism section 118b may include a plurality of second sides, including the second pair of optically coupled interfaces 122a, 122b, and the second pair of optically coupled interfaces 122a, 122b may be physically coupled by at least one intervening side 122c of the plurality of second sides such that the second relative angle is fixed and is rotationally insensitive to the external influences. Alternatively, the second pair of optically coupled interfaces 122a, 122b may join at a single point. In some implementations, the second pair of optically coupled interfaces 122a, 122b may form a second folding optics arrangement that is rotationally insensitive to the external influences. In some implementations, the second prism section 118b may be a penta prism.

The third prism section 118c may be arranged in at least one of the first optical path 110 or the second optical path 112. In the example shown in FIG. 1, the third prism section 118c is arranged in the first optical path 110 and the second optical path 112. The third prism section 118c may be a path equalizing prism section that is configured to equalize respective path lengths of the first optical path 110 and the second optical path 112 such that the first optical path 110 and the second optical path 112 have equal optical path lengths. In some implementations, the first optical path 110 may extend, at least in part, from the first optical component 114 to a first FP output of the prism arrangement. The second optical path 112 may extend, at least in part, from the first optical component 114 to a second FP output of the prism arrangement. The first optical path 110 and the second optical path 112 may extend to the beam steering system 102. For example, the first optical path may extend from the input 106 to the beam steering system 102 and the second optical path 112 may extend from the input 106 to the beam steering system 102.

The third prism section 118c may a rectangular prism that has a first dimension along the first optical path 110 and a second dimension along the second optical path 112. The first and the second dimensions of the third prism section 118c may be designed such that the first optical path 110 and the second optical path 112 have equal optical path lengths. In other words, the first and the second dimensions of the third prism section 118c may be designed based on a difference in optical path lengths of the first prism section 118a and the second prism section 118b. In some implementations, the third prism section 118c may be configured to equalize respective path lengths of the first optical path 110 and the second optical path 112 such that the first optical path 110 and the second optical path 112 have equal physical path lengths.

The first prism section 118a, the second prism section 118b, and the third prism section 118c may be made of a same optical material (e.g., a same glass material) such that the first prism section 118a, the second prism section 118b, and the third prism section 118c have a same refractive index. When the first prism section 118a, the second prism section 118b, and the third prism section 118c have the same refractive index, the first optical path 110 and the second optical path 112 may have equal optical path lengths when the first optical path 110 and the second optical path 112 have equal physical path lengths.

In some implementations, the third prism section 118c may be optically bonded to the first prism section 118a and the second prism section 118b such that the first prism section 118a, the second prism section 118b, and the third prism section 118c form a one-piece integral structure made of a homogeneous medium (e.g., a single optical material). Optically bonding the first prism section 118a, the second prism section 118b, and the third prism section 118c together may result in interfaces between conjoined prism sections being absent. The first prism section 118a, the second prism section 118b, and the third prism section 118c may be optical contact bonded prisms that have contact regions (e.g., contact interfaces) that are homogeneous such that a light beam passing through a contact region remains entirely linear. Moreover, the optical contact bonding used to bond the prism sections 118a, 118b, and 118c may eliminate epoxy joints. Thus, the prism arrangement may be devoid of epoxy interfaces. The third prism section 118c may ensure that propagation times of the first optical path 110 and the second optical path 112 are equal, thereby reducing or eliminating PMD. In some implementations, the first prism section 118a, the second prism section 118b, and the third prism section 118c may be fabricated from a unitary piece of material to form a one-piece integral structure made of a homogeneous medium.

As indicated above, FIG. 1 is provided as an example. Other examples may differ from what is described with regard to FIG. 1.

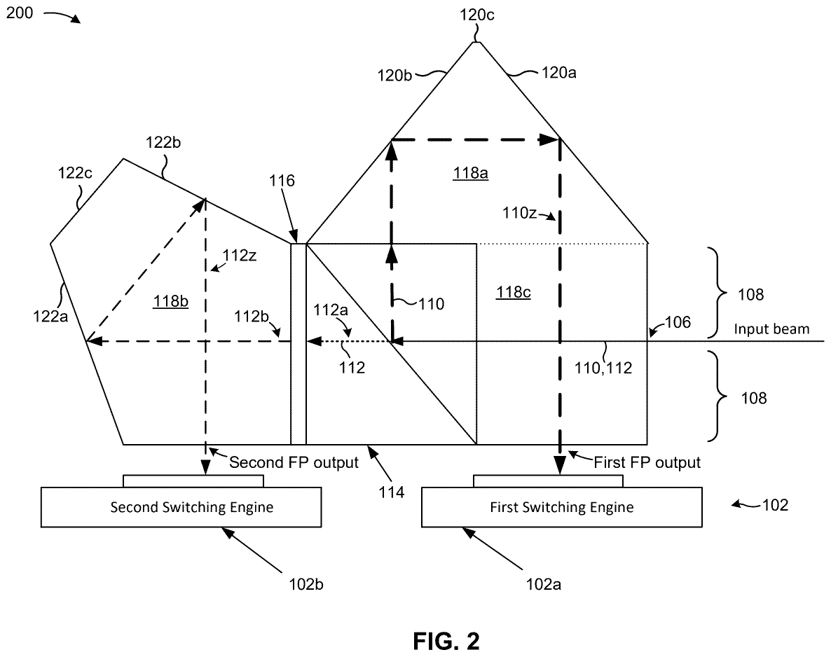

FIG. 2 shows an optical system 200 according to one or more implementations. The optical system 200 may be part of a WSS. The optical system 200 may be similar to the optical system 100 described in connection with FIG. 1. However, the beam steering system 102 of the optical system 200 may have two switching engines, including a first switching engine 102a arranged on the first optical path 110 and configured to receive the first polarized beam, and a second switching engine 102b arranged on the second optical path 112 and configured to receive the second polarized beam, with the first polarization (e.g., the third polarized beam). The first switching engine 102a and the second switching engine 102b may be arranged at a same side of the optical system 200 (e.g., a same side of the prism arrangement). Thus, the redirected path segment 110z of the first optical path 110 may be parallel to the redirected path segment 112z of second optical path 112.

The first optical component 114 and the second optical component 116 may be arranged between the second prism section 118b and the third prism section 118c. The third prism section 118c may be arranged in the redirected path segment 110z of the first optical path 110. The third prism section 118c may be optically bonded to the first prism section 118a such that the first prism section 118a and the third prism section 118c form a one-piece integral structure made of a homogeneous medium. In some implementations, the first prism section 118a and the third prism section 118c may be fabricated from a unitary piece of material to form a one-piece integral structure made of a homogeneous medium. The third prism section 118c may be configured to equalize the optical path lengths of the first optical path 110 and the second optical path 112. In some implementations, the third prism section 118c may be configured to equalize the physical path lengths of the first optical path 110 and the second optical path 112. The third prism section 118c may ensure that propagation times of the first optical path 110 and the second optical path 112 are equal, thereby reducing or eliminating PMD.

As indicated above, FIG. 2 is provided as an example. Other examples may differ from what is described with regard to FIG. 2.

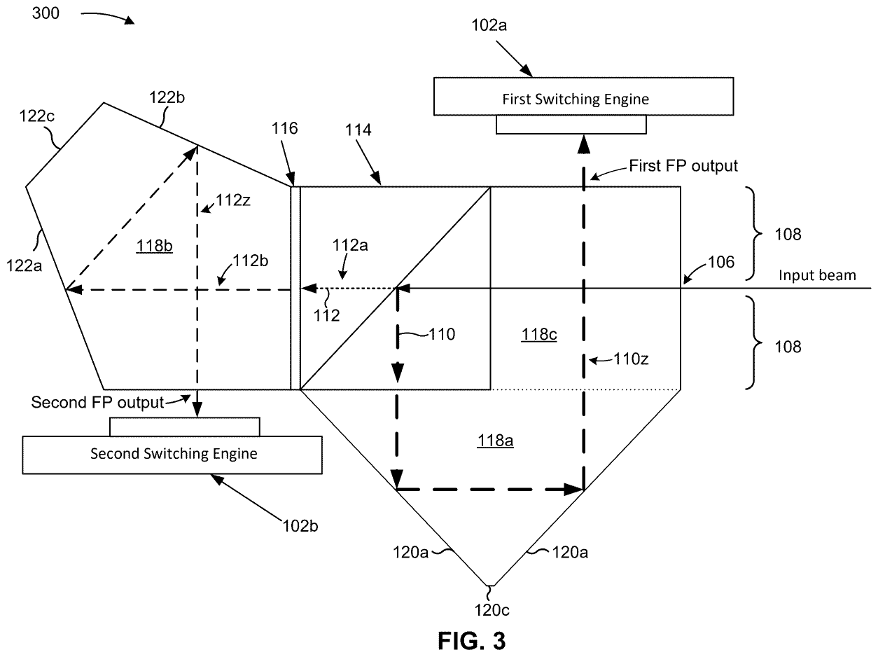

FIG. 3 shows an optical system 300 according to one or more implementations. The optical system 300 may be part of a WSS. The optical system 300 may be similar to the optical system 100, described in connection with FIG. 1, and the optical system 200, described in connection with FIG. 2. However, the beam steering system 102 of the optical system 200 may have two switching engines arranged at opposite sides of the optical system 300 (e.g., opposite sides of the prism arrangement). The beam steering system 102 may include the first switching engine 102a arranged on the first optical path 110 at a first side of the prism arrangement and configured to receive the first polarized beam. Additionally, the beam steering system 102 may include the second switching engine 102b arranged on the second optical path 112 at a second, opposite side of the prism arrangement and configured to receive the second polarized beam, with the first polarization (e.g., the third polarized beam). Due to the first switching engine 102a and the second switching engine 102b being arranged at opposite sides of the optical system 200, the redirected path segment 110z of the first optical path 110 may be antiparallel to the redirected path segment 112z of second optical path 112.

The first optical component 114 and the second optical component 116 may be arranged between the second prism section 118b and the third prism section 118c. The third prism section 118c may be arranged in the redirected path segment 110z of the first optical path 110. The third prism section 118c may be optically bonded to the first prism section 118a such that the first prism section 118a and the third prism section 118c form a one-piece integral structure made of a homogeneous medium. In some implementations, the first prism section 118a and the third prism section 118c may be fabricated from a unitary piece of material to form a one-piece integral structure made of a homogeneous medium. The third prism section 118c may be configured to equalize the optical path lengths of the first optical path 110 and the second optical path 112. In some implementations, the third prism section 118c may be configured to equalize the physical path lengths of the first optical path 110 and the second optical path 112. The third prism section 118c may ensure that propagation times of the first optical path 110 and the second optical path 112 are equal, thereby reducing or eliminating PMD.

As indicated above, FIG. 3 is provided as an example. Other examples may differ from what is described with regard to FIG. 3.

The following provides an overview of some Aspects of the present disclosure:

Aspect 1: An optical system, comprising: a beam steering system configured with a beam-steering dependency dependent on a first polarization, wherein the beam steering system is configured to steer only light having the first polarization; and an optical arrangement comprising an input, a first optical path, and a second optical path, wherein the input is configured to receive an input beam with an arbitrary polarization state, and wherein the first optical path and the second optical path are colinear at the input and are incident on the beam steering system at a different points-of-incidence, wherein the optical arrangement further comprises: a first optical component configured to split the input beam into two orthogonally polarized beams including a first polarized beam and a second polarized beam, wherein the first optical component is configured to direct the first polarized beam along the first optical path with the first polarization, and direct the second polarized beam along the second optical path with a second polarization that is orthogonal to the first polarization; a second optical component configured to receive the second polarized beam, rotate the second polarization of the second polarized beam into the first polarization, and direct the second polarized beam further along the second optical path with the first polarization; and a prism arrangement comprising: a first prism section arranged in the first optical path, the first prism section comprising a first pair of optically coupled interfaces configured to redirect the first polarized beam, at a first redirection angle, at the beam steering system, wherein the first redirection angle is rotationally insensitive to external influences; and a second prism section arranged in the second optical path, the second prism section comprising a second pair of optically coupled interfaces configured to redirect the second polarized beam, with the first polarization, at a second redirection angle, at the beam steering system, wherein the second redirection angle is rotationally insensitive to the external influences.

Aspect 2: The optical system of Aspect 1, wherein a redirected path segment of first optical path is parallel or antiparallel to a redirected path segment of second optical path, wherein the redirected path segment of first optical path extends from an output of the first pair of optically coupled interfaces to the beam steering system, and wherein the redirected path segment of second optical path extends from an output of the second pair of optically coupled interfaces to the beam steering system.

Aspect 3: The optical system of Aspect 2, wherein the first pair of optically coupled interfaces are configured to redirect the first polarized beam 180°, and wherein the second pair of optically coupled interfaces are configured to redirect the second polarized beam, with the first polarization, 90°.

Aspect 4: The optical system of Aspect 2, wherein the first pair of optically coupled interfaces are configured to rotate a propagation direction of the first polarized beam 180°, and wherein the second pair of optically coupled interfaces are configured to rotate a propagation direction of the second polarized beam, with the first polarization, 90°.

Aspect 5: The optical system of any of Aspects 1-4, wherein the first pair of optically coupled interfaces extend at a first relative angle to each other, and the first relative angle is fixed and is rotationally insensitive to the external influences, and wherein the second pair of optically coupled interfaces extend at a second relative angle to each other, and the second relative angle is fixed and is rotationally insensitive to the external influences.

Aspect 6: The optical system of Aspect 5, wherein the first prism section includes a plurality of first sides, including the first pair of optically coupled interfaces, and the first pair of optically coupled interfaces are physically coupled by at least one intervening side of the plurality of first sides such that the first relative angle is fixed and is rotationally insensitive to the external influences, and wherein the second prism section includes a plurality of second sides, including the second pair of optically coupled interfaces, and the second pair of optically coupled interfaces are physically coupled by at least one intervening side of the plurality of second sides such that the second relative angle is fixed and is rotationally insensitive to the external influences.

Aspect 7: The optical system of any of Aspects 1-6, wherein external influences include temperature and aging effects.

Aspect 8: The optical system of any of Aspects 1-7, wherein the prism arrangement comprises: a third prism section arranged in at least one of the first optical path or the second optical path, wherein the first optical path extends from the input to the beam steering system, wherein the second optical path extends from the input to the beam steering system, and wherein the third prism section is configured to equalize respective path lengths of the first optical path and the second optical path such that the first optical path and the second optical path have equal physical path lengths.

Aspect 9: The optical system of Aspect 8, wherein the first prism section, the second prism section, and the third prism section are made of a same optical material.

Aspect 10: The optical system of Aspect 8, wherein the first prism section is a dove prism, wherein the second prism section is a penta prism, and wherein the third prism section is a rectangular prism.

Aspect 11: The optical system of Aspect 8, wherein the third prism section is optically bonded to the first prism section such that the first prism section and the third prism section form a one-piece integral structure made of a homogeneous medium.

Aspect 12: The optical system of any of Aspects 1-11, wherein the prism arrangement comprises: a third prism section arranged in at least one of the first optical path or the second optical path, wherein the first optical path extends from the input to the beam steering system, wherein the second optical path extends from the input to the beam steering system, and wherein the third prism section is configured to equalize respective path lengths of the first optical path and the second optical path such that the first optical path and the second optical path have equal optical path lengths.

Aspect 13: The optical system of any of Aspects 1-12, wherein a redirected path segment of first optical path is parallel to a redirected path segment of second optical path, wherein the redirected path segment of first optical path extends from an output of the first pair of optically coupled interfaces to the beam steering system, and wherein the redirected path segment of second optical path extends from an output of the second pair of optically coupled interfaces to the beam steering system.

Aspect 14: The optical system of Aspect 13, wherein the beam steering system comprises: a single switching engine arranged on the first optical path and the second optical path, the single switching engine configured to receive the first polarized beam and the second polarized beam, with the first polarization.

Aspect 15: The optical system of Aspect 13, wherein the prism arrangement comprises: a third prism section arranged in the first optical path and the second optical path, wherein the first optical path extends from the input to the beam steering system, wherein the second optical path extends from the input to the beam steering system, and wherein the third prism section is configured to equalize respective path lengths of the first optical path and the second optical path such that the first optical path and the second optical path have equal physical path lengths.

Aspect 16: The optical system of Aspect 15, wherein the third prism section is optically bonded to the first prism section and the second prism section such that the first prism section, the second prism section, and the third prism section form a one-piece integral structure made of a homogeneous medium.

Aspect 17: The optical system of Aspect 13, wherein the beam steering system comprises: a first switching engine arranged on the first optical path and configured to receive the first polarized beam; and a second switching engine arranged on the second optical path and configured to receive the second polarized beam, with the first polarization.

Aspect 18: The optical system of any of Aspects 1-17, wherein a redirected path segment of first optical path is antiparallel to a redirected path segment of second optical path, wherein the redirected path segment of first optical path extends from an output of the first pair of optically coupled interfaces to the beam steering system, and wherein the redirected path segment of second optical path extends from an output of the second pair of optically coupled interfaces to the beam steering system.

Aspect 19: The optical system of Aspect 18, wherein the beam steering system comprises: a first switching engine arranged on the first optical path and configured to receive the first polarized beam; and a second switching engine arranged on the second optical path and configured to receive the second polarized beam, with the first polarization.

Aspect 20: The optical system of any of Aspects 1-19, wherein the first pair of optically coupled interfaces form a first folding optics arrangement, and wherein the second pair of optically coupled interfaces form a second folding optics arrangement.

Aspect 21: The optical system of any of Aspects 1-20, wherein the first optical path has a first physical path length that extends from the input to the beam steering system, the second optical path has a second physical path length that extends from the input to the beam steering system, and the first physical path length and the second physical path length are equal.

Aspect 22: The optical system of any of Aspects 1-21, wherein the first optical path has a first optical path length that extends from the input to the beam steering system, the second optical path has a second optical path length that extends from the input to the beam steering system, and the first optical path length and the second optical path length are equal.

Aspect 23: The optical system of any of Aspects 1-22, wherein the optical system is a wavelength selective switch (WSS), and the beam steering system includes at least one liquid-crystal-on-silicon (LCOS) array.

Aspect 24: An optical arrangement for a wavelength selective switch, the optical arrangement comprising: a first optical component configured to split an input beam into two orthogonally polarized beams including a first polarized beam and a second polarized beam, wherein the first optical component is configured to direct the first polarized beam along a first optical path with a first polarization, and direct the second polarized beam along a second optical path with a second polarization that is orthogonal to the first polarization; a second optical component configured to receive the second polarized beam, rotate the second polarization of the second polarized beam into the first polarization to produce a third polarized beam, and direct the third polarized beam further along the second optical path; and a prism arrangement comprising: a first prism section arranged in the first optical path, the first prism section comprising a first pair of optically coupled interfaces configured to redirect the first polarized beam, at a first redirection angle, along a redirected path segment of the first optical path, wherein the first redirection angle is rotationally insensitive to external influences; and a second prism section arranged in the second optical path, the second prism section comprising a second pair of optically coupled interfaces configured to redirect the third polarized beam, at a second redirection angle, along a redirected path segment of the second optical path, wherein the second redirection angle is rotationally insensitive to the external influences, wherein the redirected path segment of first optical path is parallel or antiparallel to the redirected path segment of second optical path.

Aspect 25: The optical arrangement of Aspect 24, wherein the first optical path and the second optical path have equal optical path lengths.

Aspect 26: The optical arrangement of any of Aspects 24-25, further comprising: a third prism section arranged in at least one of the first optical path or the second optical path, and wherein the third prism section is configured to equalize respective path lengths of the first optical path and the second optical path such that the first optical path and the second optical path have equal physical path lengths.

Aspect 27: The optical arrangement of Aspect 26, wherein the first optical path extends from the first optical component to a first forward propagation output of the prism arrangement, and wherein the second optical path extends from the first optical component to a second forward propagation output of the prism arrangement.

Aspect 28: The optical arrangement of any of Aspects 24-27, further comprising: a third prism section arranged in at least one of the first optical path or the second optical path, and wherein the third prism section is configured to equalize respective path lengths of the first optical path and the second optical path such that the first optical path and the second optical path have equal optical path lengths.

Aspect 29: A system configured to perform one or more operations recited in one or more of Aspects 1-28.

Aspect 30: An apparatus comprising means for performing one or more operations recited in one or more of Aspects 1-28.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
a beam steering system configured with a beam-steering dependency dependent on a first polarization, wherein the beam steering system is configured to steer only light having the first polarization; and
an optical arrangement comprising an input, a first optical path, and a second optical path, wherein the input is configured to receive an input beam with an arbitrary polarization state, and wherein the first optical path and the second optical path are colinear at the input and are incident on the beam steering system at a different points-of-incidence,
wherein the optical arrangement further comprises:
a first optical component configured to split the input beam into two orthogonally polarized beams including a first polarized beam and a second polarized beam, wherein the first optical component is configured to direct the first polarized beam along the first optical path with the first polarization, and direct the second polarized beam along the second optical path with a second polarization that is orthogonal to the first polarization;
a second optical component configured to receive the second polarized beam, rotate the second polarization of the second polarized beam into the first polarization, and direct the second polarized beam further along the second optical path with the first polarization; and
a prism arrangement comprising:
a first prism section arranged in the first optical path, the first prism section comprising a first pair of optically coupled interfaces configured to redirect the first polarized beam, at a first redirection angle, at the beam steering system, wherein the first redirection angle is rotationally insensitive to external influences; and
a second prism section arranged in the second optical path, the second prism section comprising a second pair of optically coupled interfaces configured to redirect the second polarized beam, with the first polarization, at a second redirection angle, at the beam steering system, wherein the second redirection angle is rotationally insensitive to the external influences.

2. The optical system of claim 1, wherein a redirected path segment of first optical path is parallel or antiparallel to a redirected path segment of second optical path,
wherein the redirected path segment of first optical path extends from an output of the first pair of optically coupled interfaces to the beam steering system, and
wherein the redirected path segment of second optical path extends from an output of the second pair of optically coupled interfaces to the beam steering system.

3. The optical system of claim 2, wherein the first pair of optically coupled interfaces are configured to redirect the first polarized beam 180°, and
wherein the second pair of optically coupled interfaces are configured to redirect the second polarized beam, with the first polarization, 90°.

4. The optical system of claim 2, wherein the first pair of optically coupled interfaces are configured to rotate a propagation direction of the first polarized beam 180°, and
wherein the second pair of optically coupled interfaces are configured to rotate a propagation direction of the second polarized beam, with the first polarization, 90°.

5. The optical system of claim 1, wherein the first pair of optically coupled interfaces extend at a first relative angle to each other, and the first relative angle is fixed and is rotationally insensitive to the external influences, and
wherein the second pair of optically coupled interfaces extend at a second relative angle to each other, and the second relative angle is fixed and is rotationally insensitive to the external influences.

6. The optical system of claim 5, wherein the first prism section includes a plurality of first sides, including the first pair of optically coupled interfaces, and the first pair of optically coupled interfaces are physically coupled by at least one intervening side of the plurality of first sides such that the first relative angle is fixed and is rotationally insensitive to the external influences, and
wherein the second prism section includes a plurality of second sides, including the second pair of optically coupled interfaces, and the second pair of optically coupled interfaces are physically coupled by at least one intervening side of the plurality of second sides such that the second relative angle is fixed and is rotationally insensitive to the external influences.

7. The optical system of claim 1, wherein external influences include temperature and aging effects.

8. The optical system of claim 1, wherein the prism arrangement comprises:
a third prism section arranged in at least one of the first optical path or the second optical path,
wherein the first optical path extends from the input to the beam steering system,
wherein the second optical path extends from the input to the beam steering system, and
wherein the third prism section is configured to equalize respective path lengths of the first optical path and the second optical path such that the first optical path and the second optical path have equal physical path lengths.

9. The optical system of claim 8, wherein the first prism section, the second prism section, and the third prism section are made of a same optical material.

10. The optical system of claim 8, wherein the first prism section is a dove prism,
wherein the second prism section is a penta prism, and
wherein the third prism section is a rectangular prism.

11. The optical system of claim 8, wherein the third prism section is optically bonded to the first prism section such that the first prism section and the third prism section form a one-piece integral structure made of a homogeneous medium.

12. The optical system of claim 1, wherein the prism arrangement comprises:
a third prism section arranged in at least one of the first optical path or the second optical path,
wherein the first optical path extends from the input to the beam steering system,
wherein the second optical path extends from the input to the beam steering system, and
wherein the third prism section is configured to equalize respective path lengths of the first optical path and the second optical path such that the first optical path and the second optical path have equal optical path lengths.

13. The optical system of claim 1, wherein a redirected path segment of first optical path is parallel to a redirected path segment of second optical path,
wherein the redirected path segment of first optical path extends from an output of the first pair of optically coupled interfaces to the beam steering system, and
wherein the redirected path segment of second optical path extends from an output of the second pair of optically coupled interfaces to the beam steering system.

14. The optical system of claim 13, wherein the beam steering system comprises:
a single switching engine arranged on the first optical path and the second optical path, the single switching engine configured to receive the first polarized beam and the second polarized beam, with the first polarization.

15. The optical system of claim 13, wherein the prism arrangement comprises:
a third prism section arranged in the first optical path and the second optical path,
wherein the first optical path extends from the input to the beam steering system,
wherein the second optical path extends from the input to the beam steering system, and
wherein the third prism section is configured to equalize respective path lengths of the first optical path and the second optical path such that the first optical path and the second optical path have equal physical path lengths.

16. The optical system of claim 15, wherein the third prism section is optically bonded to the first prism section and the second prism section such that the first prism section, the second prism section, and the third prism section form a one-piece integral structure made of a homogeneous medium.

17. The optical system of claim 13, wherein the beam steering system comprises:
a first switching engine arranged on the first optical path and configured to receive the first polarized beam; and
a second switching engine arranged on the second optical path and configured to receive the second polarized beam, with the first polarization.

18. The optical system of claim 1, wherein a redirected path segment of first optical path is antiparallel to a redirected path segment of second optical path,
wherein the redirected path segment of first optical path extends from an output of the first pair of optically coupled interfaces to the beam steering system, and
wherein the redirected path segment of second optical path extends from an output of the second pair of optically coupled interfaces to the beam steering system.

19. The optical system of claim 18, wherein the beam steering system comprises:
a first switching engine arranged on the first optical path and configured to receive the first polarized beam; and
a second switching engine arranged on the second optical path and configured to receive the second polarized beam, with the first polarization.

20. The optical system of claim 1, wherein the first pair of optically coupled interfaces form a first folding optics arrangement, and
wherein the second pair of optically coupled interfaces form a second folding optics arrangement.

21. The optical system of claim 1, wherein the first optical path has a first physical path length that extends from the input to the beam steering system,
the second optical path has a second physical path length that extends from the input to the beam steering system, and
the first physical path length and the second physical path length are equal.

22. The optical system of claim 1, wherein the first optical path has a first optical path length that extends from the input to the beam steering system,
the second optical path has a second optical path length that extends from the input to the beam steering system, and
the first optical path length and the second optical path length are equal.

23. The optical system of claim 1, wherein the optical system is a wavelength selective switch (WSS), and the beam steering system includes at least one liquid-crystal-on-silicon (LCOS) array.

24. An optical arrangement for a wavelength selective switch, the optical arrangement comprising:
a first optical component configured to split an input beam into two orthogonally polarized beams including a first polarized beam and a second polarized beam, wherein the first optical component is configured to direct the first polarized beam along a first optical path with a first polarization, and direct the second polarized beam along a second optical path with a second polarization that is orthogonal to the first polarization;
a second optical component configured to receive the second polarized beam, rotate the second polarization of the second polarized beam into the first polarization to produce a third polarized beam, and direct the third polarized beam further along the second optical path; and
a prism arrangement comprising:
a first prism section arranged in the first optical path, the first prism section comprising a first pair of optically coupled interfaces configured to redirect the first polarized beam, at a first redirection angle, along a redirected path segment of the first optical path, wherein the first redirection angle is rotationally insensitive to external influences; and
a second prism section arranged in the second optical path, the second prism section comprising a second pair of optically coupled interfaces configured to redirect the third polarized beam, at a second redirection angle, along a redirected path segment of the second optical path, wherein the second redirection angle is rotationally insensitive to the external influences,
wherein the redirected path segment of first optical path is parallel or antiparallel to the redirected path segment of second optical path.

25. The optical arrangement of claim 24, wherein the first optical path and the second optical path have equal optical path lengths.

26. The optical arrangement of claim 24, further comprising:
a third prism section arranged in at least one of the first optical path or the second optical path, and
wherein the third prism section is configured to equalize respective path lengths of the first optical path and the second optical path such that the first optical path and the second optical path have equal physical path lengths.

27. The optical arrangement of claim 26, wherein the first optical path extends from the first optical component to a first forward propagation output of the prism arrangement, and
wherein the second optical path extends from the first optical component to a second forward propagation output of the prism arrangement.

28. The optical arrangement of claim 24, further comprising:
a third prism section arranged in at least one of the first optical path or the second optical path, and
wherein the third prism section is configured to equalize respective path lengths of the first optical path and the second optical path such that the first optical path and the second optical path have equal optical path lengths.
